(19) United States
(12) Patent Application Publication
(10) Pub. No.: US 2026/0335940 A1
(43) Pub. Date: Oct. 29, 2026

(54) Method for Cleaning Workpiece Carriers for Battery Cell Lacquering, Device for Cleaning Workpiece Carriers for Battery Cell Lacquering, and Vehicle

(71) Applicant: Bayerische Motoren Werke Aktiengesellschaft, Muenchen (DE)

(72) Inventors: Julian HACKL, Muenster (DE); Thomas MAYER, Regensburg (DE); Tobias MENDLER, Allershausen (DE); Sebastian SCHNEIDER, Erding (DE)

(21) Appl. No.: 19/113,463

(22) PCT Filed: Sep. 19, 2023
(86) PCT No.: PCT/EP2023/075733

§ 371 Date: Mar. 20, 2025

(30) Foreign Application Priority Data
Sep. 22, 2022 (DE) 10 2022 124 319.2

(51) Int. Cl. B08B 1/10; B23C 3/00

(52) U.S. Cl. CPC B08B 1/10; B23C 3/00; B23C 2220/48

(57) ABSTRACT

The invention relates to a method for cleaning workpiece carriers (16) for battery cell lacquering, in which method a coating applied to the workpiece carrier (16) during the battery cell lacquering is removed by mechanical machining. The invention further relates to a device (40) for cleaning workpiece carriers (16) for battery cell lacquering, and to a vehicle having a battery with at least one battery cell which is lacquered with a workpiece carrier (16) which is cleaned by a method according to the invention and/or a device according to the invention.

### BACKGROUND AND SUMMARY

The present disclosure relates to a method for cleaning workpiece carriers for battery cell varnishing. The disclosure further relates to a device for cleaning workpiece carriers for battery cell varnishing and to a vehicle comprising a battery having at least one battery cell varnished by way of a workpiece carrier cleaned by way of such a method and/or such a device.

In the manufacture of battery cells, a casing of the battery cell is varnished to forestall a short circuit between two battery cells and the presence of a voltage at the casing.

For example, DE 10 2018 128 501 A1 discloses a method for coating a battery cell of a vehicle battery that involves coating the battery cell with an insulating varnish layer.

The casing is varnished in a varnishing and curing station in which varnish first is applied to the casing and then is cured. The battery cells are conveyed through the varnishing and curing station via individual pushed-together workpiece carriers. These battery cells hover on the workpiece carriers or on a workpiece carrier belt formed by the pushed-together workpiece carriers, with their pole side downward. During varnishing, the workpiece carriers likewise become varnished. In the subsequent curing step, the wet battery cell varnish is cured and therefore adheres to the workpiece carriers as well. These carriers must then be freed from the adhering varnish in an extra operating step before unvarnished cells are again placed onto the workpiece carriers for varnishing.

It is an object of the present disclosure to provide a method, a device and a vehicle which enable improved cleaning of a workpiece carrier for battery cell varnishing.

According to a first aspect of the disclosure, a method is proposed for cleaning workpiece carriers for battery cell varnishing. The method involves removing a coating applied on the workpiece carrier during battery cell varnishing, by way of mechanical working.

Through the use of a mechanical working method for cleaning the workpiece carrier, the coating is removed without removing the carrier material of the workpiece carrier. As a result, uniform varnishing of the battery cells positioned on the workpiece carriers is consistently enabled. Moreover, relative to CO2 cleaning, for example, the method of the disclosure features low operating costs, as no CO2 is required, and also a lower noise level.

In one advantageous configuration, the workpiece carrier is composed of Teflon.

The method advantageously takes place immediately after a varnishing and curing station.

The coating applied may be an insulating varnish which is applied to a battery cell, more particularly on a casing of the battery cell.

The method of the disclosure whereby the coating applied to the workpiece carrier is removed rules out the use of sandblasting, CO2 cleaning, scrapers, doctor blades or scratchers as a form of mechanical working, as all of these cause abrasion to the carrier material and are consequently very costly and, moreover, feature a high noise level.

In one advantageous configuration, the coating is removed from the workpiece carrier by milling. The milling may take place in a separate device—a milling station, for example—which is downstream of a varnishing and curing station. The device may comprise a containment. Cleaning the workpiece carriers by way of a milling operation makes it possible for only the coating, especially the cured varnish, to be benignly removed from the workpiece carrier. As a result, there is no abrasion on the workpiece carrier and therefore no wear on the workpiece carrier. As a result, uniform varnishing of the battery cells positioned on the workpiece carriers is consistently enabled.

In one advantageous configuration, three individual milling cutters are used for the milling. Advantageously, furthermore, the individual milling cutters used are two side milling cutters and one plain milling cutter.

In one advantageous configuration, one individual milling cutter works a top side of the workpiece carrier and the other two individual milling cutters work the mutually opposite long sides of the workpiece carrier. Advantageously, the long sides of the workpiece carrier are worked by way of the two side milling cutters and the top side is worked by way of the plain milling cutter. The plain milling cutter advantageously comprises a projection by way of which an indentation for accommodating a pole of the battery cell is cleaned.

In one advantageous configuration, the workpiece carrier is mechanically worked in such a way that the workpiece carrier has the original geometry, or the initial geometry, it had prior to varnishing. After cleaning, therefore, the workpiece carrier has the initially generated geometry. Accordingly, the coating, more particularly the cured varnish, is milled off in a targeted way, retaining the workpiece carrier geometry without further mechanical abrasion of workpiece carrier material. Results of this are wear optimization of the workpiece carrier, economy in replacement-part management, and a reduction in operating costs.

Flawless varnishing of the battery cells requires the workpiece carrier to have its initially generated geometry, since the varnishing operation responds very sensitively to the slightest geometric changes or alignments of the application unit relative to the battery cell. In the event of a change to the geometry of the workpiece carrier owing to the cleaning operation, the battery cell to be varnished would no longer lie on the workpiece carrier in the manner originally approved. As a result, the application parameters of the application unit that were originally set for the initial geometry of the workpiece carrier are irrelevant, since the orientation of the battery cell relative to the application unit is then different and, therefore, product requirements which are to be achieved by the varnishing are no longer met. Since the workpiece carrier after the mechanical working has its initial geometry, the product requirements arising from the varnishing are therefore met.

In one advantageous configuration, the workpiece carrier is generated by way of the mechanical working by introducing an initial geometry or original geometry into a blank, the initial geometry or original geometry being used as a starting measurement for the mechanical working of the workpiece carrier. Initially, therefore, a blank, such as a rectangular block of Teflon, for example, is milled to geometry, for example by milling an indentation into the rectangular Teflon block and/or machining long sides of the Teflon block. The milling positions set are stored and adopted subsequently for the individual milling cutters for removing the coating. As a result, after the varnishing and curing station, the workpiece carriers are milled in a targeted way and hence the initial workpiece carrier geometry is retained without further mechanical abrasion of the workpiece carrier material, more particularly Teflon material. Furthermore, the manufacturing costs for the workpiece carriers are reduced, since all that is needed is a block, which is milled by a milling station to the workpiece carrier geometry.

In one advantageous configuration, an indentation for accommodating a battery cell is introduced as initial geometry into the blank. A pole of a battery cell engages into the indentation. The indentation is introduced advantageously into a top side of the blank. Advantageously, furthermore, the indentation is introduced into the blank by way of a plain milling cutter. The plain milling cutter for this purpose may have a projection.

According to a further aspect of the disclosure, a device is proposed for cleaning workpiece carriers for battery cell varnishing. The device comprises a mechanical working device for implementing a method of the disclosure.

The device may be embodied as a milling station, downstream of a varnishing and curing station. The device may comprise a containment.

The mechanical working device advantageously comprises three individual milling cutters. Advantageously, furthermore, the mechanical working device comprises a plain milling cutter and two side milling cutters. Advantageously, long sides of the workpiece carrier are worked by way of the two side milling cutters and a top side of the workpiece carrier is worked by way of the plain milling cutter. The plain milling cutter advantageously comprises a projection by way of which an indentation for accommodating a pole of the battery cell is introduced into the workpiece carrier and/or cleaned.

In one advantageous configuration, the device comprises a workpiece carrier generation station which is upstream of a varnishing and curing station and which comprises a mechanical working device for introducing a geometry into a blank.

In one advantageous configuration, the mechanical working device comprises three individual milling cutters, with two milling cutters being embodied as side milling cutters and one milling cutter being embodied as a plain milling cutter.

According to a further aspect of the disclosure, a vehicle is proposed which comprises a battery having at least one battery cell varnished by way of a workpiece carrier cleaned by way of a method of the disclosure and/or a device of the disclosure.

### BRIEF DESCRIPTION OF THE DRAWINGS

Below, a vehicle, a device for cleaning workpiece carriers for battery cell varnishing, a method for cleaning workpiece carriers for battery cell varnishing, and also further features and advantages, are described in more detail with reference to exemplary embodiments which are represented schematically in the figures.

FIG. 1 shows a vehicle having a battery formed of battery cells;

FIG. 2 shows a workpiece carrier for battery cell varnishing, with a battery cell disposed thereon;

FIG. 3 shows a schematic representation of the production of the workpiece carrier represented in FIG. 2;

FIG. 4 shows an enlarged representation of a device for cleaning and/or producing the workpiece carrier; and

FIG. 5 shows a schematic representation of a varnishing and curing station and of a downstream device for cleaning the workpiece carriers.

### DETAILED DESCRIPTION OF THE DRAWINGS

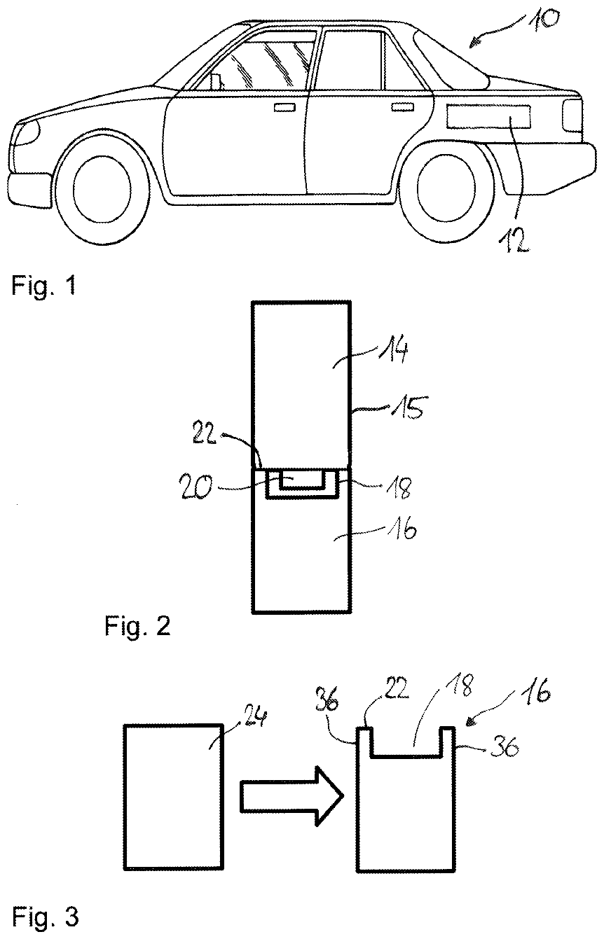

FIG. 1 shows a vehicle 10 which is operated by an electric motor, not represented, which is supplied with electrical energy from a battery 12.

The battery 12 has a multiplicity of battery cells 14, which are represented schematically in FIG. 2. The battery cell 14, more particularly a casing 15 of the battery cell 14, is varnished to forestall a short circuit between two adjacent battery cells 14 and also the presence of a voltage at the battery cell 14.

For the varnishing of the battery cell 14, it is placed on a workpiece carrier 16, as evident in FIG. 2. For this, the workpiece carrier 16 has an indentation 18 into which a pole 20 of the battery cell 14 engages. The casing 15 of the battery cell 14 lies on a top side 22 of the workpiece carrier 16.

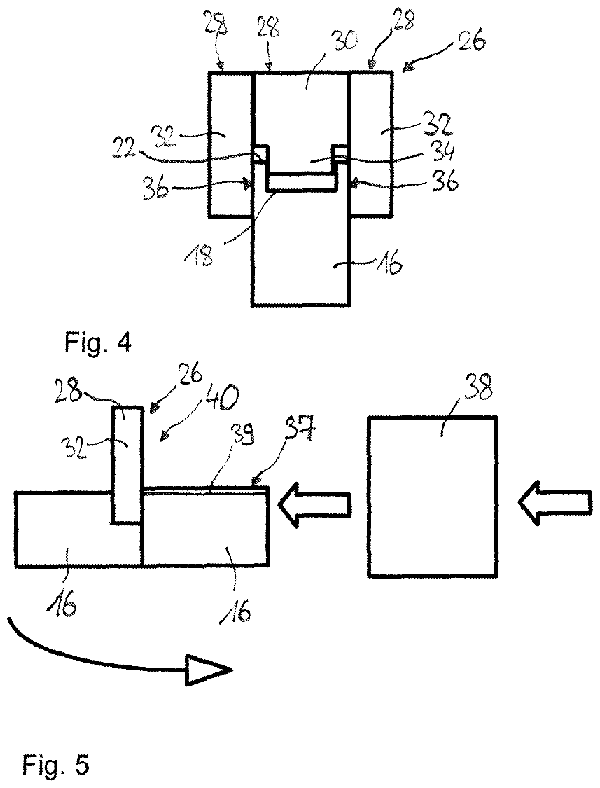

To generate an initial geometry or original geometry of the workpiece carrier 16, a rectangular Teflon blank 24 is worked mechanically, as represented schematically in Fig. 3. For this, the blank 24 is worked by way of the mechanical working device 26 represented in FIG. 4.

The mechanical working device 26 has three individual milling cutters 28, with one milling cutter 28 being embodied as a plain milling cutter 30 and two milling cutters 28 being embodied as side milling cutters 32. The two side milling cutters 32 work the mutually opposite long sides 36 of the workpiece carrier 16. The plain milling cutter 30 works the top side 22 of the workpiece carrier 16, and more particularly the plain milling cutter 30 introduces the indentation 18 into the top side 22 of the workpiece carrier 16. For this, the plain milling cutter 30 has a projection 34, as evident in FIG. 4.

Represented schematically in FIG. 5 is a varnishing and curing station 40, in which the battery cells 14 arranged on the workpiece carrier 16 are first coated, more particularly varnished, after which the applied coating 37, more particularly the varnish 39, is cured.

During the varnishing of the battery cells 14, the workpiece carriers 16 are varnished too. To free the workpiece carriers 16 of the cured varnish 39, a device 40 for cleaning the workpiece carriers 16 is positioned downstream of the varnishing and curing device 38, as represented schematically in FIG. 5. The device 40 comprises the mechanical working device 26 represented in FIG. 4 for cleaning the workpiece carriers 16. The device 40, more particularly its mechanical working device 26 comprising the plain milling cutter 30 and the two side milling cutters 32, mill the workpiece carrier 16 to the initial geometry or original geometry. For this, the milling positions of the plain milling cutter 30 and of the side milling cutters 32 that were set during the production of the workpiece carrier 16 are adopted for the mechanical working device 26. As a result, in a targeted way, only the adhering cured varnish 39 is milled off, and the initial geometry or original geometry of the workpiece carrier 16 is retained without further mechanical abrasion of the workpiece carrier material, more particularly the Teflon material.

When the workpiece carriers 16 have been freed of the adhering cured varnish 39, they can be repopulated with new battery cells 14 and then supplied to the varnishing and curing station 38, as represented schematically in FIG. 5 by way of the arrows.

A feature of the device 40 and of the method for cleaning the workpiece carrier 16 is that the adhering cured varnish 39 is milled off in a targeted manner by the milling of the workpiece carrier 16 to its initial geometry or original geometry. As a result, the workpiece carrier geometry is retained without further mechanical abrasion of the workpiece carrier material. Furthermore, reductions are achieved in the wear of the workpiece carriers 16, in the costs of replacement-part management, and in the operating costs.

### LIST OF REFERENCE SIGNS

10 vehicle
12 battery
14 battery cell
15 casing
16 workpiece carrier
18 indentation
20 pole
22 top side
24 blank
26 mechanical working device
28 individual milling cutter
30 plain milling cutter
32 side milling cutter
34 projection
36 long side
37 coating
38 varnishing and curing station
39 varnish
40 device

1.-10. (canceled)

11. A method for cleaning workpiece carriers for battery cell varnishing, comprising applying a coating a to the workpiece carrier during battery cell varnishing, and removing the coating byway of mechanical working.

12. The method according to claim 11, wherein the coating is removed from the workpiece carrier by way of milling.

13. The method according to claim 12, wherein three individual milling cutters are used for the milling.

14. The method according to claim 13, wherein one individual milling cutter works a top side of the workpiece carrier and the other two individual milling cutters work the mutually opposite long sides of the workpiece carrier.

15. The method according to claim 11, wherein the workpiece carrier is mechanically worked such that the workpiece carrier has the initial geometry it had prior to varnishing.

16. The method according to claim 11, wherein the workpiece carrier is generated by way of the mechanical working by introducing an initial geometry into a blank, the initial geometry being used as a starting measurement for the mechanical working of the workpiece carrier.

17. The method according to claim 16, wherein an indentation for accommodating a battery cell is introduced as initial geometry into the blank.

18. A device for cleaning workpiece carriers for battery cell varnishing, comprising a mechanical working device for implementing a method according to claim 11.

19. The device according to claim 18, wherein the mechanical working device comprises three individual milling cutters.

20. A vehicle comprising a battery having at least one battery cell varnished by way of a workpiece carrier cleaned by way of a method according to claim 11.

21. A vehicle comprising a battery having at least one battery cell varnished by way of a workpiece carrier cleaned by way of a device according to claim 18.
